(19) United States
(12) Patent Application Publication
(10) Pub. No.: US 2023/0286767 A1
(43) Pub. Date: Sep. 14, 2023

(54) MACHINE AND METHOD FOR EXTENDING A MESH OVER A LAMINAR MATERIAL

(71) Applicant: KEELTEK ENGINEERING SOLUTIONS, S.L., Almazora, Castellón (ES)

(72) Inventors: Daniel PLÁ CUESTA, Almazora (ES); Vicente MOLLAR SANAHUJA, Almazora (ES)

(73) Assignee: KEELTEK ENGINEERING SOLUTIONS, S.L., Almazora, Castellón (ES)

(21) Appl. No.: 18/040,887

(22) PCT Filed: Feb. 15, 2021
(86) PCT No.: PCT/ES2021/070104

§ 371 Date: Feb. 7, 2023

(30) Foreign Application Priority Data
Aug. 7, 2020 (ES) P202030851

(51) Int. Cl. B65H 20/16; B65H 35/00

(52) U.S. Cl. CPC B65H 20/16; B65H 35/0006; B65H 2701/121

(57) ABSTRACT

A machine for extending a mesh over a laminar material, including a motorless reel holder shaft with an overrun brake, three clamps through which the mesh runs disposed perpendicularly to the movement of the components to be covered, one of these with a disc cutter. The unrolling of the reel is caused by the advance of at least one of the clamps when closed. It features a control unit, a component detection barrier, and elements for the mesh retained to flex prior to being released upon the component, by moving both clamps together. A method for extending a mesh over a laminar material using the aforementioned machine is also provided.

### FIELD

To allow the placement of a portion of mesh cut from a coil on a static or moving laminar material in such a way that the first area of contact with it is close to a line located in the center of the piece and perpendicular to the direction of advancement.

### BACKGROUND

The need to provide a coating that improves the properties of certain lamellar materials such as ceramic tiles, plaster slabs or coverings leads the industry to apply different processes, from the manual application of a mesh fixed by means of an adhesive and/or different resins either by spraying or rolling to the systematization by means of different equipment that allows automating these processes. In this sense, machines such as the one described in document ES2208003A1 of the applicant Pablo Villoria Suárez de Cepeda are known, which automatically spreads a fiberglass mesh on a natural stone slab coming from a coil placed on a shaft, this invention does not allow an exact positioning on the piece by touching the cut mesh portion at different points of the piece to be reinforced by the dragging produced, differing from the recommended one.

The applicant does not know of technical solutions such as the one recommended that allow positioning the mesh on a laminar material avoiding the problem of dragging or friction of the mesh with the material to be coated.

### SUMMARY

It is usual in the industry that different laminar materials, especially stone materials such as ceramic pieces or different coatings, receive a reinforcement on their non-aesthetic side to improve their mechanical properties and/or their adherence to the future support.

This can be done by placing a mesh on these surfaces, which is fixed by various adhesive techniques (use of sprayed resins, spatula rollers ...), an operation that when automated is usually performed from a motorized roller or coil on which the mesh is placed to be deposited on the laminar material, the portions of mesh adapted to the size of the material are cut by conventional means such as a cutting disc that runs transversely to the direction of advancement of the pieces. The complexity of this portion of mesh being centered on the part forces current systems to reduce the speed of this type of installation and sometimes to apply an adhesive on the laminar material to fix the mesh prior to subsequent spraying with resin.

It would therefore be desirable to find a technical solution that overcomes this difficulty, to these effects the present invention has on the belt on which the pieces are deposited and moved means to place a coil of mesh on an axis that has an inertia brake whose mission is that the coil does not move in any direction if a preset force is not exceeded, the free end of the mesh is guided and introduced into a jaw whose lips have a laminar geometry as a tray that is transverse to the direction of advance and that can be moved longitudinally. After the first jaw described above, there is a new pair of jaws transversal to the feed direction that hold the mesh, which are again allowed to move independently in both directions. This movement, when it is in the feed direction and at least one of the jaws is closed, is the one that unwinds the bobbin, this allows to calculate in a simple way the mesh portion to be used without having to adapt the angular speed of the coil depending on the diameter of the coiled mesh at that moment, since the linear movement of the jaws supplies the same mesh portion independently of the thickness of the coil. It has a cutting system by means of a toothed disc that runs transversally to the direction of advance located in the intermediate or second motorized jaw.

The pair of jaws, second and third, that transports the mesh portion to be placed on the laminar piece moves firstly in the direction of advance maintaining a distance between them such that the mesh is taut, cutting this portion when it has the desired length by the means described. When the position of the mesh already cut coincides with the piece to be coated at least one of the described motorized jaws approaches slightly to the other which causes the mesh to untension and curve touching the laminar piece, opening then its jaws. The fact that the cut part comes into contact with the part to be coated in a line close to the center of the part avoids the dragging problem of other systems that the mesh presents, improving the exact positioning and speed of the system.

The procedure performed by the machine starts by loading the coil on a nonmotor shaft with an inertia brake, after which the free end of the mesh is tensioned through a roller from which it enters a first jaw whose lips have a laminar arrangement as a tray; detection of the size of the pieces, their position and speed to estimate the portion of mesh required and the movement of the jaws by means of at least one photocell barrier; loading of the required mesh portion between the lips of the second and third jaws; cutting of the mesh portion; positioning of the mesh portion on the laminar piece; approaching of the jaws with the consequent bending of the mesh contained in them towards the piece to be coated; opening of the lips of the jaws, which can separate from each other by releasing the cut mesh; return of the second and third jaws to load the mesh and start the cycle.

### BRIEF DESCRIPTION OF THE DRAWINGS

For a better understanding of what is described in the present report, some drawings are included in which, by way of example, a list of the figures of the proposed invention is shown.

FIG. 1 illustrates the conveyor belt (9) on which the laminar piece (8) is placed, the mesh (4) is arranged on a coil whose axis has an inertia brake (5), the three jaws can be seen, (1) next to the coil whose jaws have a tray-like configuration, after this the second jaw (2) which has a disc cutter (6), and finally the third jaw (3); the arrows indicate the translation movement that the three jaws are allowed to make.

FIG. 2 shows the jaws (2 and 3) retaining a portion of the mesh (7) placed on the laminar piece (8) and the cutting disc (6).

FIG. 3 illustrates how the approach of the jaws (2 and 3) to each other causes a bending of the mesh (7) that brings it closer to the laminar material (8).

FIG. 4 shows the instant in which after opening both jaws and separating them (2 and 3) the mesh portion (7) extends covering the laminar material (8).

The following figures are introduced to bring clarity to the sequence of movements of the jaws and when they operate open or closed:

FIG. 5, first jaw at point of travel close to the coil with its lips (1′) open and the web inserted through these; jaws (2 and 3) are adjacent and their lips open (2′ and 3′).

FIGS. 6 and 7 show the relative movement between the first jaw with its closed lips inserted into the second and third jaws.

In FIGS. 8 and 9 the lips of the first jaw are open and it is retracted at least from the third jaw, a portion of the free webbing can be seen between the lips of the third jaw.

FIG. 10, the mesh can be seen retained by the pressure action of the lips of the third jaw.

FIG. 11, third jaw closed and advancing with the mesh in the direction of the laminar piece to be coated, the first and second jaws being open.

FIG. 12 shows the closing of the second jaw when the mesh length is as desired, the action after closing the cut-off wheel can also be seen.

In FIG. 13 the second and third jaws have been moved and centered on the laminar piece to be coated.

FIG. 14 shows how the relative approach of the second and third jaws, with their lips closed and retaining the cut mesh portion, causes a bending of the latter towards the laminar piece.

In FIG. 15 the lips of the second and third jaws are open, distancing both jaws from each other, allowing the mesh to fall.

FIG. 16 shows how the open second and third jaws return to the first one to start the mesh loading cycle again.

### DETAILED DESCRIPTION OF THE EMBODIMENTS

A preferred embodiment is given by way of example, the materials used in its manufacture, as well as the methods of application and all the accessory details which may arise, provided that they do not affect its essentiality, being independent of the subject matter of the invention.

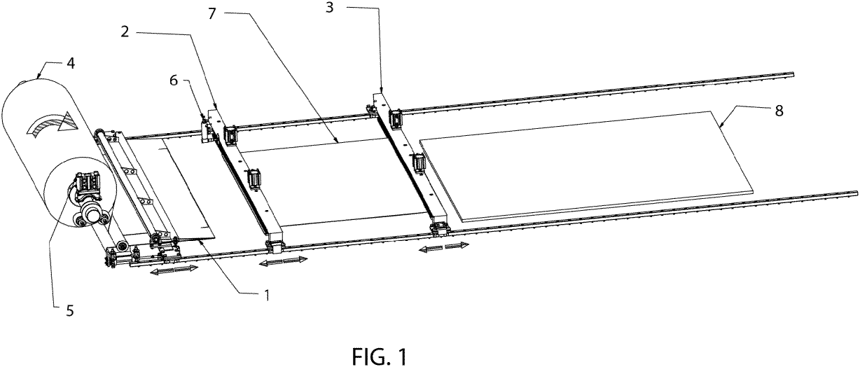

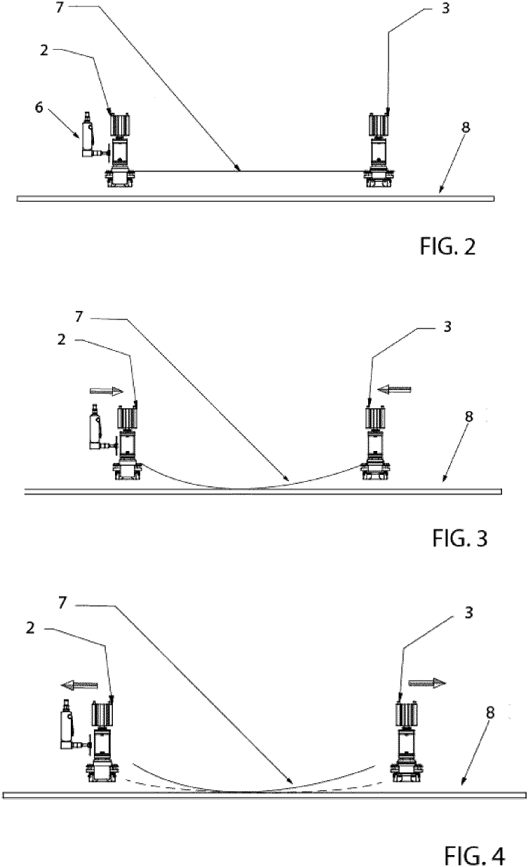

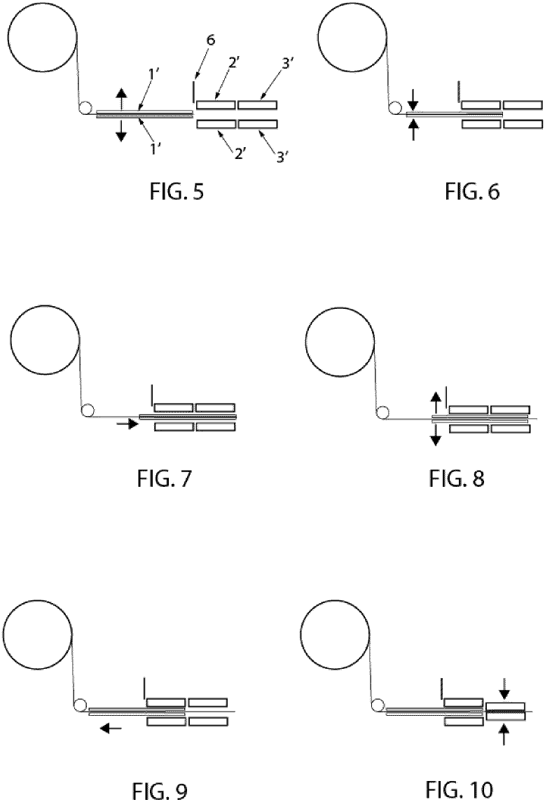

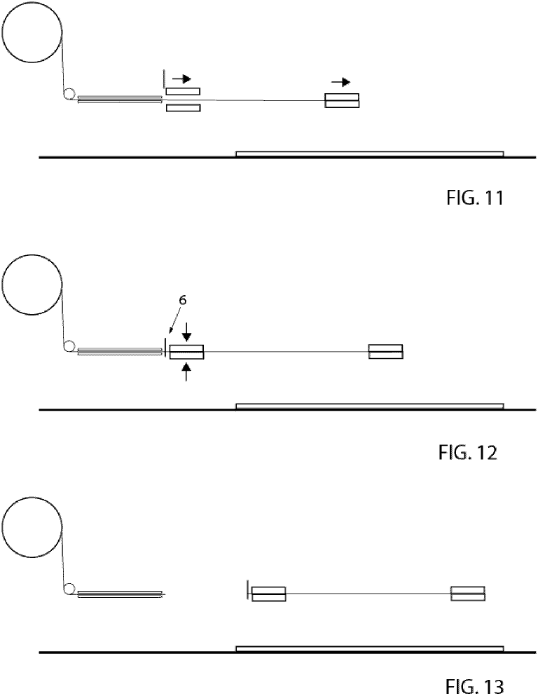

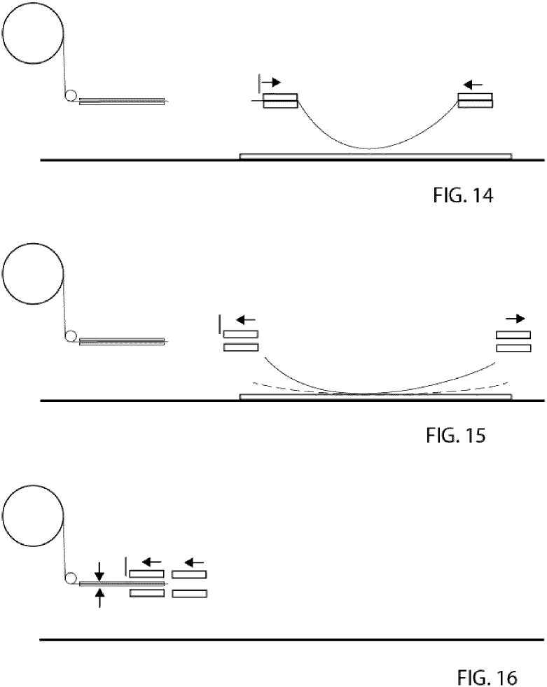

The machine and procedure for the placement of a mesh on a laminar material object of this preferred embodiment contains the features claimed in the first and second claims in such a way that the placement of a portion of cut mesh on a laminar piece starts from a bobbin (4) which is arranged on a non-motorized shaft having an inertia brake (5), this brake prevents the coil from unwinding accidentally, when the mesh is pulled by overcoming the force exerted by the inertia brake it is possible to unwind the coil, FIG. 1. The mesh is tensioned and driven through a guide roller and introduced into a first jaw (1) whose lips have a laminar arrangement as a tray, this jaw can move longitudinally, FIGS. 5 to 9. It includes a second and third jaw (2 and 3) that collect and transport the mesh on the laminar piece (8) to be coated, allowing its longitudinal displacement in both directions; by means of a control unit and at least one photocell barrier (not shown), the position and size of the piece to be coated are known, thus determining the length of the mesh required and the position that the jaws (2 and 3) must travel to the piece. It includes a disc cutter (6) FIG. 3 that runs installed and parallel to the second jaw that operates to obtain the necessary mesh portion by making a transversal cut to the mesh advance direction. The lips of the second and third jaws open and penetrate inside the first one to receive and pull the mesh, in this way the closed third jaw (with the first one retracted) pulls the coil, FIGS. 10 and 11, when the portion has the calculated length the second jaw closes and cuts the mesh by means of the described disc cutter, FIG. 12. Both jaws (2 and 3) keep the cut portion taut, transporting it in unison on the laminar piece to be coated. Once the cut mesh portion is placed on the laminar piece, it has means to generate a bending in this one that causes the mesh to come into contact with the material to be coated along a line located in the middle of the piece and the mesh, these means are facilitated when the second and third jaws approach each other at that moment, FIG. 14; after this, the lips of the jaws open and separate the latter letting the mesh fall, FIG. 15. The jaws (2 and 3) are again approached open towards the coil and first jaw to start the loading cycle, FIG. 16.

1-2. (canceled)

3. A machine for placing a mesh on laminar material, comprising the mesh wound on a non-motorized reel holder shaft with an inertia brake, comprising three jaws through which the mesh runs and is retained, the three jaws are arranged perpendicular to the feed direction of the parts to be coated and which, to the three jaws open and close, allowing for longitudinal displacement; wherein a first jaw close to the coil in which at least one of its clamping faces is a plate as a tray, behind it a second jaw which has a disc cutter with a transverse displacement to the feed and behind it a third jaw, the unwinding of the coil is produced by the feed of at least one of the closed jaws; the machine further comprising a control unit that calculates the relative position between the jaws and the pieces according to the feed speed and the size of the laminar material, the control unit positions the jaws on the static or moving piece, having means for the retained mesh to flex before being released on the piece, bringing the two jaws closer together; it includes at least one detection barrier of the pieces by means of photocells before the jaws.

4. A method for placing a mesh on laminar material according to claim 1, comprising:
replacing the mesh wound on a non-motorized reel holder shaft equipped with an inertia brake;
detecting the parts by means of at least one photocell barrier;
unwinding the required portion of coil by pulling at least one closed jaw;
adjusting the distance and movement of the second and third jaws on the static or moving laminar piece, by means of a control unit;
cutting the web portion of the coil by means of a disc cutter located in the jaw;
allowing after positioning of the cut mesh portion on the laminar piece the latter to flex causing it to touch the laminar piece establishing a line of contact, by approaching the jaws retaining the mesh portion;
opening of the jaws to release the mesh on the laminate part; and
returning of the second and third jaws to the coil to start the mesh loading cycle.
